(19) United States
(12) Patent Application Publication
(10) Pub. No.: US 2015/0098639 A1
(43) Pub. Date: Apr. 9, 2015

(54) Image Processing System, Image Processing Method and Image Processing Program

(71) Applicants: Kazuhiko Matsumoto, Palo Alto, CA (US); Pita4 Mobile LLC, Palo Alto, CA (US)

(72) Inventor: Kazuhiko Matsumoto, Palo Alto, CA (US)

(73) Assignee: Pita4 Mobile LLC, Palo Alto, CA (US)

(21) Appl. No.: 14/048,312

(22) Filed: Oct. 8, 2013

(51) Int. Cl. G06F 19/00; H04N 1/00; G06T 11/00

(52) U.S. Cl. CPC G06F 19/321; G06T 11/005; H04N 1/00244; G06T 2207/10088; G06T 2207/10081; G06T 2207/10132; G06T 2207/10108; H04N 2201/0079
USPC 382/131

(57) ABSTRACT

Provided is an image processing system including a server and a scanning device connected with the server through a network. The scanning device includes a measurement unit that performs multiple times of measurement required to reconstruct one image on a target to obtain a plurality of pieces of measurement data, and a data transmission unit that transmits the plurality of pieces of measurement data obtained by the measurement unit to the server. The server includes a data reception unit that receives the plurality of pieces of measurement data transmitted by the data transmission unit, and a reconstructed image creation unit that creates a reconstructed image on the basis of the plurality of pieces of measurement data received by the data reception unit.

### BACKGROUND OF THE INVENTION

1. Field of the Invention

The present invention relates to an image processing system, an image processing method, and an image processing program, and more particularly, to an image processing system that includes a server and a scanning device connected with the server through a network, an image processing method using the image processing system, and an image processing program that is executed in the image processing system.

2. Background Art

Examples of an image processing system that acquires a cross-section image of a target such as a human body or an object include an X-Ray computed tomography (CT) apparatus, a nuclear magnetic resonance imaging (MRI) apparatus, and the like. An MRI system using a predetermined technique is disclosed in Japanese Unexamined Patent Application Publication No. 2009-268901.

In such a system of the related art, a scanning device that measures a target and an image processing apparatus for creating a reconstructed image from measurement data are integrally formed and installed.

In addition, since a complicated process is required to create a high-quality reconstructed image, the image processing apparatus is required to have an advanced performance in order to shorten a processing time. Furthermore, in recent years, research into algorithms such as compression sensing requiring more advanced repeated calculations has been conducted, but these new algorithms require a far greater amount of calculation processing as compared with the related art, and thus the new algorithms require a further higher calculation performance.

However, as the image processing apparatus has a higher performance, the apparatus becomes expensive. Thus, it is not possible to easily install the scanning device and the image processing apparatus in terms of costs.

On the other hand, there is high demand for an image processing system in a medical field and other fields, and thus immediate solutions to the above-described problems have been desired.

### SUMMARY OF THE INVENTION

An object of the invention is to solve the above-described problems and to provide an image processing system, an image processing method, and an image processing program which are capable of processing measurement data measured by a scanning device and providing a reconstructed image, at low cost.

According to an aspect of the invention, there is provided an image processing system of the invention includes a server and a scanning device connected with the server through a network. The scanning device includes a measurement unit that performs multiple times of measurement required to reconstruct one image on a target to obtain a plurality of pieces of measurement data, and a data transmission unit that transmits the plurality of pieces of measurement data obtained by the measurement unit to the server. The server includes a data reception unit that receives the plurality of pieces of measurement data transmitted by the data transmission unit, and a reconstructed image creation unit that creates a reconstructed image on the basis of the plurality of pieces of measurement data received by the data reception unit.

Every time the measurement unit measures the target a predetermined number of times, the data transmission unit may transmit a predetermined number of pieces of measurement data obtained by the measurement unit to the server.

Every time the data reception unit receives a predetermined number of pieces of measurement data transmitted by the data transmission unit, the reconstructed image creation unit may create a reconstructed image from the measurement data which is received in advance by the data reception unit and measurement data which is received this time.

Every time the data reception unit receives the predetermined number of pieces of measurement data transmitted by the data transmission unit, the reconstructed image creation unit may create another reconstructed image in parallel before creation of the reconstructed image which is already in progress is finished.

The server may further include a measurement procedure transmission unit that transmits a measurement procedure, which is set in advance, to the scanning device. The scanning device may further include a measurement procedure reception unit that receives the measurement procedure transmitted by the measurement procedure transmission unit. The measurement unit may scan the target on the basis of the measurement procedure.

The server may further include a signal transmission unit that transmits a signal to start up the measurement unit. The scanning device may further include a signal reception unit that receives the signal transmitted by the signal transmission unit. The measurement unit may be started up in response to the signal.

The reconstructed image creation unit may create a reconstructed image from the plurality of pieces of measurement data received by the data reception unit, using a technique of compression sensing.

The server may further include a charge calculation unit that calculates charges to be borne by a user.

The server may further include an advertisement addition unit that adds an advertisement to the reconstructed image created by the reconstructed image creation unit.

The image processing system may further include a plurality of the scanning devices. The scanning device may be movable. The scanning device may further include a position recognition unit that recognizes a position of the scanning device, and a positional information transmission unit that transmits positional information recognized by the position recognition unit to the server. The server may further include a positional information reception unit that receives the positional information transmitted by the positional information transmission unit.

The server may designate at least one scanning device which is located at an appropriate place, out of the plurality of scanning devices, with respect to a user, on the basis of the positional information received by the positional information reception unit and a position of the user.

The server may designate an appropriate moving place with respect to at least one scanning device which is located at an appropriate place, out of the plurality of scanning devices, on the basis of the positional information received by the positional information reception unit and position of a user.

The server may further include an image display unit for displaying the reconstructed image created by the reconstructed image creation unit. The measurement unit may finish the measurement at the point when the reconstructed image displayed on the image display unit has a desired image quality.

The server may further include an image display unit that displays the reconstructed image created by the reconstructed image creation unit, and a measurement procedure modification unit that dynamically modifies the measurement procedure transmitted by the measurement procedure transmission unit.

The server may further include a reconstructed image transmission unit that transmits the reconstructed image created by the reconstructed image creation unit.

The scanning device may be an MRI apparatus.

The scanning device may be an X-ray CT apparatus, an ultrasonic imaging device, or a nuclear medicine imaging device.

According to another aspect of the invention, there is provided an image processing method using an image processing system that includes a server and a scanning device connected with the server through a network. The image processing method includes: a measurement step of causing the scanning device to perform multiple times of measurement required to reconstruct one image on a target to obtain a plurality of pieces of measurement data; a data transmission step of causing the scanning device to transmit the plurality of pieces of measurement data obtained in the measurement step to the server; a data reception step of causing the server to receive the plurality of pieces of measurement data transmitted in the data transmission step; and a reconstructed image creation step of causing the server to create a reconstructed image on the basis of the plurality of pieces of measurement data received in the data reception step.

According to another aspect of the invention, there is provided an image processing program executed in an image processing system that includes a server and a scanning device connected with the server through a network. The image processing program causes a computer to implement: measurement means for performing multiple times of measurement required to reconstruct one image on a target to obtain a plurality of pieces of measurement data; data transmission means for transmitting the plurality of pieces of measurement data obtained by the measurement means to the server; data reception means for receiving the plurality of pieces of measurement data transmitted by the data transmission means; and reconstructed image creation means for creating a reconstructed image on the basis of the plurality of pieces of measurement data received by the data reception means.

According to the invention, it is possible to provide an image processing system, an image processing method, and an image processing program at low cost.

### BRIEF DESCRIPTION OF THE DRAWINGS

FIG. 1 is a schematic diagram illustrating an example of a configuration of an image processing system of the invention;

FIG. 2 is a schematic diagram illustrating an example in which the image processing system of the invention includes a plurality of scanning devices; and

FIG. 3 is a flow chart illustrating an example of a flow of an image processing method of the invention.

### DETAILED DESCRIPTION OF THE INVENTION

Hereinafter, an embodiment of an image processing system of the invention will be described in detail with reference to the accompanying drawings.

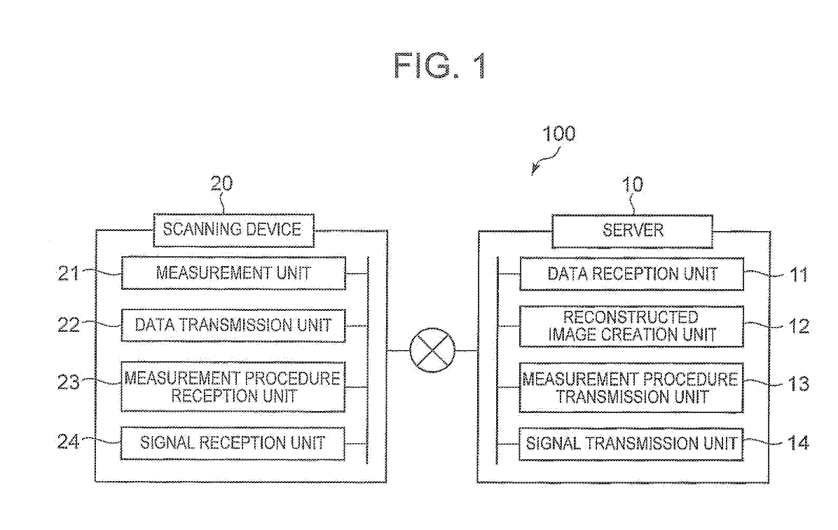

FIG. 1 is a schematic diagram illustrating an example of a configuration of the image processing system of the invention.

As illustrated in FIG. 1, an image processing system 100 of the invention includes a server 10 and a scanning device 20 connected with the server 10 through a network.

The scanning device 20 includes a measurement unit 21 and a data transmission unit 22.

The measurement unit 21 performs the multiple times of measurement required to reconstruct one image on a target to obtain a plurality of pieces of measurement data. The target can be, for example, a human, an animal, or a fruit. In general, for example, the standard number of times of measurement required to form a reconstructed image having a size of 512×512 bytes is 512 times. On the other hand, as will be described later, it is possible to reconstruct one image which is reduced in quality without performing the standard number of times of measurement. Therefore, the multiple times of measurement required to reconstruct the one image refers to measurement equal to or more than the number of times required to reconstruct an image having a minimum level of quality and equal to or less than the standard number of times.

The data transmission unit 22 transmits the plurality of pieces of measurement data obtained by the measurement unit 21 to the server 10.

The server 10 includes a data reception unit 11 and a reconstructed image creation unit 12. Meanwhile, the server 10 is not necessarily a single apparatus, and can be constituted by a plurality of equipments that are dispersively deployed.

The data reception unit 11 receives the plurality of pieces of measurement data transmitted by the data transmission unit 22.

The reconstructed image creation unit 12 creates a reconstructed image on the basis of the plurality of pieces of measurement data received by the data reception unit 11.

In this manner, according to the image processing system of the invention, the server 10 and the scanning device 20 are separately formed and are connected with each other through a network, and thus it is not necessary to provide the expensive reconstructed image creation unit 12 with respect to each scanning device 20. Therefore, it is possible to reduce the cost of installing the scanning device 20.

Here, as an example, an example will be described in which the reconstructed image creation unit 12 of the server 10 creates a reconstructed image from a plurality of pieces of measurement data obtained by an MRI apparatus which is the scanning device 20.

The MRI apparatus is an apparatus that measures information such as the amount of hydrogen atoms in the body or a state, using a nuclear magnetic resonance phenomenon and using a strong magnet and electromagnetic waves. Specifically, the MRI apparatus obtains measurement data using a nuclear magnetic resonance phenomenon of hydrogen nuclei among atomic nuclei causing a resonance phenomenon. First, a certain magnetic field is generated using a superconducting magnet, and hydrogen nuclei in the body are directed to a certain direction. Next, after electric waves are irradiated, the electric waves absorbed into the hydrogen nuclei and then discharged are measured.

On the other hand, the reconstructed image creation unit 12 analyzes measurement data of the electric waves measured by the MRI apparatus to create a reconstructed image. Specifically, the reconstructed image is created by performing a Fourier inverse transform on the measurement data.

In general, as described above, for example, 512 times of measurement are required to create one reconstructed image having a size of 512×512 bytes. For this problem, in the related art, the time for the measurement is shortened by using an MRI apparatus having a high magnetic field intensity (1.5 T to 7 T). However, the MRI apparatus having a high magnetic field intensity is expensive.

On the other hand, in recent years, a technique of obtaining one reconstructed image by reducing the number of times of measurement to 30 to 50 times and performing a predetermined analysis process has also been developed. Accordingly, although it is possible to shorten the time for the measurement regardless of a high magnetic field intensity, the analysis process becomes complex, and thus it takes a long time to perform the analysis process. This can be solved by using an image processing apparatus having a high processing capacity, but the image processing apparatus having a high processing capacity is expensive.

According to the image processing system of the invention, the server 10 and the scanning device 20 are separately formed and are connected with each other through a network, and thus it is not necessary to provide the expensive reconstructed image creation unit 12 with respect to each scanning device 20.

Meanwhile, in the above example, a method of measuring a specific two-dimensional cross-sectional portion of a target to thereby reconstruct an image equivalent to the cross-section has been described, but it is also possible to configure the system such that a specific three-dimensional portion of a target is measured to reconstruct an image corresponding to the three-dimensional space.

It is preferable that the data transmission unit 22 transmit a predetermined number of pieces of measurement data, which are obtained by the measurement unit 21 every time the measurement unit 21 measures a target a predetermined number of times, to the server 10. Thus, the server 10 can obtain the predetermined number of pieces of measurement data obtained in advance by the measurement unit 21, before the standard number of times of measurement with respect to the target is finished. Meanwhile, the standard number of times is the number of times of measurement required in a typical and standard algorithm of the related art. As described above, for example, when a reconstructed image having a size of 512×512 bytes is obtained, 512 times of measurement are the standard number of times.

It is preferable that the reconstructed image creation unit 12 creates a reconstructed image from the measurement data received in advance by the data reception unit and measurement data received this time, every time the data reception unit 11 receives the predetermined number of pieces of measurement data transmitted by the data transmission unit 22. Herein, a reconstructed image created on the basis of the number of pieces of measurement data which is less than the standard number of times is referred to as a draft image, and a reconstructed image created on the basis of the standard number of pieces of measurement data is referred to as a final image. According to the above configuration, it is possible to obtain the draft image before the final image is obtained. In addition, when the draft image has a desired quality, it is also possible to finish the measurement at the point when the draft image is acquired, without waiting for the acquisition of the final image.

Here, for description, it is assumed that the standard number of times of measurement is 16 times, and each measurement is referred to as K0 to K15, respectively. Then, processes in the measurement unit 21, the measurement data transmission unit 22, and the reconstructed image creation unit 12 are as follows.

1) The measurement unit 21 measures K0 and K8, and the measurement data transmission unit 22 transmits these pieces of measurement data. 2) The reconstructed image creation unit 12 creates a draft image 1 from the received pieces of measurement data of K0 and K8.

3) The measurement unit 21 measures K4 and K12, and the measurement data transmission unit 22 transmits these pieces of measurement data. 4) The reconstructed image creation unit 12 creates a draft image 2 from the pieces of measurement data of K0 and K8 which are received in advance and pieces of measurement data of K4 and K12 which are received this time.

5) The measurement unit 21 measures K2, K6, K10, and K14, and the measurement data transmission unit 22 transmits these pieces of measurement data. 6) The reconstructed image creation unit 12 creates a draft image 3 from the pieces of measurement data of K0, K4, K8, and K12 which are received in advance and pieces of measurement data of K2, K6, K10, and K14 which are received this time.

7) The measurement unit 21 measures K1, K3, K5, K7, K9, K11, K13, and K15, and the measurement data transmission unit 22 transmits these pieces of measurement data. 8) The reconstructed image creation unit 12 creates a final image from the pieces of measurement data of K0, K2, K4, K6, K8, K10, K12, and K14 which are received in advance and pieces of measurement data of K1, K3, K5, K7, K9, K11, K13, and K15 which are received this time. That is, the final image is created from all the pieces of measurement data of K0 to K15.

It is preferable that the reconstructed image creation unit 12 create another reconstructed image in parallel before the creation of a reconstructed image which is already in progress is finished, every time the data reception unit 11 receives the predetermined number of pieces of measurement data transmitted by the data transmission unit 22. Herein, a reconstructed image created on the basis of the number of pieces of measurement data which is less than the standard number of times is referred to as a draft image, and a reconstructed image created on the basis of the standard number of pieces of measurement data is referred to as a final image. According to the above configuration, it is possible to continuously obtain a plurality of draft images while improving their qualities, and a timing at which a final image created on the basis of all the standard number of pieces of measurement data is obtained is not delayed.

The server 10 further includes a measurement procedure transmission unit 13, the scanning device 20 further includes a measurement procedure reception unit 23, and the measurement unit 21 can scan a target on the basis of a measurement procedure. Thus, the server 10 can designate the measurement procedure of the target based on the scanning device 20.

The measurement procedure transmission unit 13 transmits a measurement procedure, which is set in advance or set dynamically, to the scanning device 20. The measurement procedure which is set in advance is a measurement procedure which is created and set by a doctor or the like before the measurement is started.

The measurement procedure reception unit 23 receives the measurement procedure transmitted by the measurement procedure transmission unit 13.

The server 10 further includes a signal transmission unit 14, the scanning device 20 further includes a signal reception unit 24, and the measurement unit 21 can be started up in response to the signal. Thus, the server 10 can start up the measurement unit 21 of the scanning device 20.

The signal transmission unit 14 transmits a signal to start up the measurement unit 21.

The signal reception unit 24 receives the signal transmitted by the signal transmission unit 14.

The reconstructed image creation unit 12 can create a reconstructed image from the plurality of pieces of measurement data received by the data reception unit 11 using a technique of compression sensing. The compression sensing is a technique that reduces the time and cost of measurement by reducing a plurality of standard number of times of measurement without degrading the quality of a final image as much as possible. An MRI apparatus has a data space referred to as a k-space which is constituted by a plurality of pieces of measurement data, and measurement is generally performed in the related art in such a manner that the whole k-space is filled. On the other hand, in the compression sensing, only a small amount of measurement is performed so as to fill only a portion of a k-space. When there is an attempt to obtain an MRI image having a size of 512×512 bytes using the related art, 512 times of measurement are required to fill a k-space. For example, it is known that when approximately 100 times of measurement corresponding to straight lines, having a plurality of different angles, which pass through the center of a k-space are performed, a coherent image is obtained as a whole in spite of a slight degradation in image quality.

The server 10 can further include a charge calculation unit (not shown) which calculates charges to be borne by a user. The charges to be borne by a user are, for example, charges imposed on the user with respect to a part beyond a basic service.

The server 10 can further include an advertisement addition unit (not shown) which adds an advertisement to the reconstructed image created by the reconstructed image creation unit 12. Thus, it is possible to reduce or eliminate the burden of a user in terms of charges because a sponsor absorbs the charges in the form of advertisement rates.

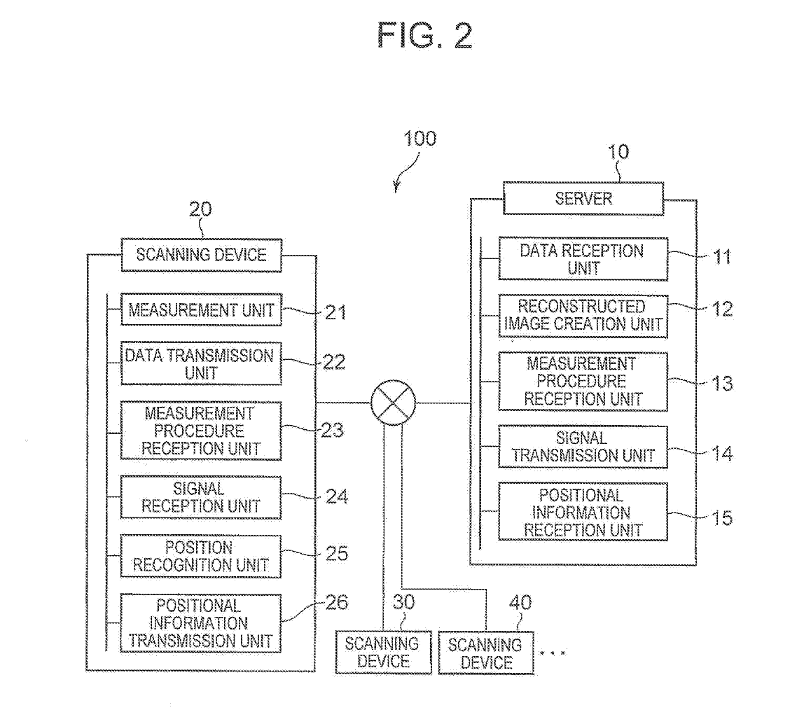

FIG. 2 is a schematic diagram illustrating an example in which the image processing system 100 includes a plurality of the scanning devices (in FIG. 2, scanning devices 20, 30, and 40) which are connected with the server 10 through a network. Meanwhile, FIG. 2 illustrates an example in which three scanning devices are provided, but is not limited thereto. In addition, hereinafter, the scanning device 20 will be described, but the same is true of the other scanning devices.

At this time, the scanning device 20 can further include a position recognition unit 25 and a positional information transmission unit 26, and the server 10 can further include a positional information reception unit 15.

The position recognition unit 25 can be a GPS or the like which recognizes the position of the scanning device 20.

The positional information transmission unit 26 transmits the positional information recognized by the position recognition unit 25 to the server 10.

The positional information reception unit 15 receives the positional information transmitted by the positional information transmission unit 26.

Furthermore, with respect to a user the server 10 can designate at least one scanning device (for example, the scanning device 20), which is located at an appropriate place, out of the plurality of scanning devices 20, 30, and 40, on the basis of the positional information received by the positional information reception unit 15 and the position of the user. Accordingly, the user can head for the designated appropriate (for example, nearest or accessible) place of the scanning device and be measured, and thus convenience can be improved. Meanwhile, the user can be not only a person to be measured but also, for example, an operator of an ambulance.

The scanning devices 20, 30, and 40 are movable, and the server 10 can further designate an appropriate moving place with respect to at least one scanning device (for example, the scanning device 20), which is located at an appropriate place, out of the plurality of scanning devices 20, 30, and 40, on the basis of the positional information received by the positional information reception unit 15 and the position of the user. This can be realized, for example, by mounting the scanning device on a vehicle. Accordingly, the convenience of the user can be improved.

The server 10 can further include an image display unit (not shown) for displaying the reconstructed image created by the reconstructed image creation unit 12, and the measurement unit 21 can finish the measurement at the point when the reconstructed image displayed on the image display unit has a desired image quality. Specifically, the image displayed on the image display unit can be confirmed by a doctor or the like, and the server 10 can transmit an instruction to finish the measurement to the measurement unit 21 at the point when it is confirmed that the reconstructed image has a desired image quality.

The server 10 can further include the image display unit (not shown) for displaying the reconstructed image created by the reconstructed image creation unit 12 and a measurement procedure modification unit (not shown) for dynamically modifying the measurement procedure transmitted by the measurement procedure transmission unit 13. Specifically, a doctor or the like can confirm the image displayed on the image display unit and modify the measurement procedure when necessary. The modified measurement procedure is dynamically modified.

The server 10 can further include a reconstructed image transmission unit (not shown) for transmitting the reconstructed image created by the reconstructed image creation unit 12. Thus, the created reconstructed image can be transmitted to a user, a scanning device, or other remote locations.

Examples of the scanning device 20 can include an MRI apparatus, an X-ray CT apparatus, an ultrasonic imaging device, and a nuclear medicine imaging device.

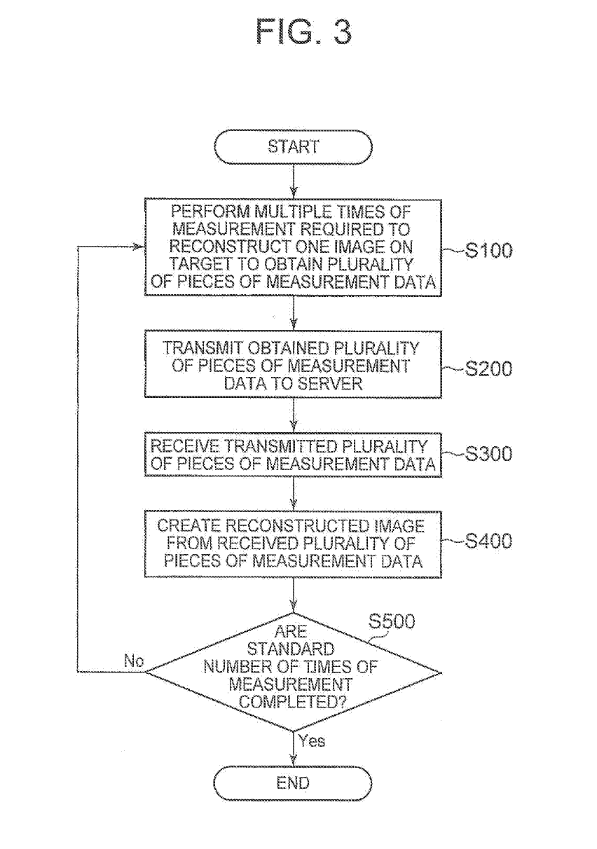

Subsequently, an embodiment of an image processing method of the invention will be described with reference to the accompanying drawings. FIG. 3 is a flow chart illustrating an example of a flow of the image processing method of the invention.

As illustrated in FIG. 3, the image processing method of the invention is an image processing method using an image processing system that includes a server and a scanning device connected with the server through a network, and includes a measurement step, a data transmission step, a data reception step, and a reconstructed image creation step.

In the measurement step, the multiple times of measurement required to reconstruct one image are performed on a target by the scanning device 20 to obtain a plurality of pieces of measurement data (S100). This process is performed, for example, by the measurement unit 21 of the scanning device 20. The details of the measurement unit 21 are as described above.

In the data transmission step, the plurality of pieces of measurement data obtained in the measurement step (S100) are transmitted to the server 10, by the scanning device 20 (S200). This process is performed by, for example, the data transmission unit 22 of the scanning device 20. The details of the data transmission unit 22 are as described above.

In the data reception step, the plurality of pieces of measurement data transmitted in the data transmission step (S200) are received by the server 10 (S300). This process is performed by, for example, the data reception unit 11 of the server 10. The details of the data reception unit 11 are as described above.

In the reconstructed image creation step, a reconstructed image is created on the basis of the plurality of pieces of measurement data received in the data reception step (S300) by the server 10 (S400). This process is performed by, for example, the reconstructed image creation unit 12 of the server 10. The details of the reconstructed image creation unit 12 are as described above.

The image processing method of the invention can further include a measurement frequency determination step. In the measurement frequency determination step, it is determined whether a standard number of times of measurement are completed in the measurement step (S500). When the standard number of times of measurement is not completed, the method returns to the measurement step (S100). When the standard number of times of measurement is completed, the process is finished.

Specifically, when the standard number of times is set to 512 times, a reconstructed image based on 64 times of measurement data can be created in a first loop, a reconstructed image based on 128 times of measurement data can be created in a second loop, and a reconstructed image based on 512 times of measurement data can be created in an eighth loop which is the last loop. The reconstructed image has a higher quality every time it passes through the loop, but when a reconstructed image having a desired quality is obtained before using a standard number of pieces of measurement data, it is also possible to finish the process at that point.

Subsequently, an embodiment of an image processing program of the invention will be described with reference to the accompanying drawings.

The image processing program of the invention is an image processing program executed in an image processing system that includes a server and a scanning device connected with the server through a network, and causes a computer to implement measurement means, data transmission means, data reception means, and reconstructed image creation means.

The measurement means performs the multiple times of measurement required to reconstruct one image on a target to obtain a plurality of pieces of measurement data. The measurement means is, for example, the measurement unit 21 of the scanning device 20. The details of the measurement unit 21 are as described above.

The data transmission means transmits the plurality of pieces of measurement data obtained by the measurement means to a server. The data transmission means is, for example, the data transmission unit 22 of the scanning device 20. The details of the data transmission unit 22 are as described above.

The data reception means receives the plurality of pieces of measurement data transmitted by the data transmission means. The data reception means is, for example, the data reception unit 11 of the server 10. The details of the data reception unit 11 are as described above.

The reconstructed image creation means creates a reconstructed image on the basis of the plurality of pieces of measurement data received by the data reception means. The reconstructed image creation means is, for example, the reconstructed image creation unit 12 of the server 10. The details of the reconstructed image creation unit 12 are as described above.

The above description is merely illustrative of a representative embodiment, and the invention is not limited to the embodiment.

What is claimed is:

1. An image processing system comprising:
a server; and
a scanning device connected with the server through a network,
wherein the scanning device includes
a measurement unit that performs multiple times of measurement required to reconstruct one image on a target to obtain a plurality of pieces of measurement data, and
a data transmission unit that transmits the plurality of pieces of measurement data obtained by the measurement unit to the server, and
wherein the server includes
a data reception unit that receives the plurality of pieces of measurement data transmitted by the data transmission unit, and
a reconstructed image creation unit that creates a reconstructed image on the basis of the plurality of pieces of measurement data received by the data reception unit.

2. The image processing system according to claim 1, wherein every time the measurement unit measures the target a predetermined number of times, the data transmission unit transmits a predetermined number of pieces of measurement data obtained by the measurement unit to the server.

3. The image processing system according to claim 1, wherein every time the data reception unit receives a predetermined number of pieces of measurement data transmitted by the data transmission unit, the reconstructed image creation unit creates a reconstructed image from the measurement data which is received in advance by the data reception unit and measurement data which is received this time.

4. The image processing system according to claim 3, wherein every time the data reception unit receives the predetermined number of pieces of measurement data transmitted by the data transmission unit, the reconstructed image creation unit creates another reconstructed image in parallel before creation of the reconstructed image which is already in progress is finished.

5. The image processing system according to claim 1,
wherein the server further includes a measurement procedure transmission unit that transmits a measurement procedure, which is set in advance, to the scanning device,
wherein the scanning device further includes a measurement procedure reception unit that receives the measurement procedure transmitted by the measurement procedure transmission unit, and
wherein the measurement unit scans the target on the basis of the measurement procedure.

6. The image processing system according to claim 1,
wherein the server further includes a signal transmission unit that transmits a signal to start up the measurement unit,
wherein the scanning device further includes a signal reception unit that receives the signal transmitted by the signal transmission unit, and
wherein the measurement unit is started up in response to the signal.

7. The image processing system according to claim 1, wherein the reconstructed image creation unit creates a reconstructed image from the plurality of pieces of measurement data received by the data reception unit, using a technique of compression sensing.

8. The image processing system according to claim 1, wherein the server further includes a charge calculation unit that calculates charges to be borne by a user.

9. The image processing system according to claim 1, wherein the server further includes an advertisement addition unit that adds an advertisement to the reconstructed image created by the reconstructed image creation unit.

10. The image processing system according to claim 1, further comprising a plurality of the scanning devices,
wherein the scanning device is movable,
wherein the scanning device further includes
a position recognition unit that recognizes a position of the scanning device, and
a positional information transmission unit that transmits positional information recognized by the position recognition unit to the server, and
wherein the server further includes a positional information reception unit that receives the positional information transmitted by the positional information transmission unit.

11. The image processing system according to claim 10, wherein with respect to a user, the server designates at least one scanning device which is located at an appropriate place, out of the plurality of scanning devices, on the basis of the positional information received by the positional information reception unit and a position of the user.

12. The image processing system according to claim 10, wherein the server designates an appropriate moving place with respect to at least one scanning device which is located at an appropriate place, out of the plurality of scanning devices, on the basis of the positional information received by the positional information reception unit and position of a user.

13. The image processing system according to claim 1,
wherein the server further includes an image display unit for displaying the reconstructed image created by the reconstructed image creation unit, and
wherein the measurement unit finishes the measurement at the point when the reconstructed image displayed on the image display unit has a desired image quality.

14. The image processing system according to claim 1, wherein the server further includes
an image display unit that displays the reconstructed image created by the reconstructed image creation unit, and
a measurement procedure modification unit that dynamically modifies the measurement procedure transmitted by the measurement procedure transmission unit.

15. The image processing system according to claim 1, wherein the server further includes a reconstructed image transmission unit that transmits the reconstructed image created by the reconstructed image creation unit.

16. The image processing system according to claim 1, wherein the scanning device is an MRI apparatus.

17. The image processing system according to claim 1, wherein the scanning device is an X-ray CT apparatus, an ultrasonic imaging device, or a nuclear medicine imaging device.

18. An image processing method using an image processing system that includes a server and a scanning device connected with the server through a network, the image processing method comprising:
a measurement step of causing the scanning device to perform multiple times of measurement required to reconstruct one image on a target to obtain a plurality of pieces of measurement data;
a data transmission step of causing the scanning device to transmit the plurality of pieces of measurement data obtained in the measurement step to the server;
a data reception step of causing the server to receive the plurality of pieces of measurement data transmitted in the data transmission step; and
a reconstructed image creation step of causing the server to create a reconstructed image on the basis of the plurality of pieces of measurement data received in the data reception step.

19. An image processing program executed in an image processing system that includes a server and a scanning device connected with the server through a network, the image processing program causing a computer to implement:
measurement means for performing multiple times of measurement required to reconstruct one image on a target to obtain a plurality of pieces of measurement data;
data transmission means for transmitting the plurality of pieces of measurement data obtained by the measurement means to the server;
data reception means for receiving the plurality of pieces of measurement data transmitted by the data transmission means; and
reconstructed image creation means for creating a reconstructed image on the basis of the plurality of pieces of measurement data received by the data reception means.
